(19) United States
(12) Patent Application Publication
(10) Pub. No.: US 2022/0157173 A1
(43) Pub. Date: May 19, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Takaharu UENO, Nagoya-shi (JP); Kenichi YAMADA, Nisshin-shi (JP); Ryosuke KOBAYASHI, Nagakute-shi (JP); Shintaro MATSUTANI, Kariya-shi (JP)

(73) Assignee: TOYOTA JIDOSHA KABUSHIKI KAISHA, Toyota-shi (JP)

(21) Appl. No.: 17/454,732

(22) Filed: Nov. 12, 2021

(30) Foreign Application Priority Data
Nov. 16, 2020 (JP) 2020-190169

(51) Int. Cl. G08G 1/00; G08G 1/005; G06K 9/00; B60W 60/00

(52) U.S. Cl. CPC G08G 1/202; G08G 1/207; B60W 60/001; G06K 9/0063; G08G 1/005

(57) ABSTRACT

An information processing apparatus acquires first information about movement of a shopping cart present inside a commercial facility. The information processing apparatus determines, based on the first information, whether there is an indication that a user who is using the shopping cart inside the commercial facility is leaving the commercial facility. Then, the information processing apparatus dispatches a vehicle to a specific location in a case of determining that there is the indication that the user is leaving the commercial facility.

### CROSS REFERENCE TO THE RELATED APPLICATION

This application claims the benefit of Japanese Patent Application No. 2020-190169, filed on Nov. 16, 2020, which is hereby incorporated by reference herein in its entirety.

### BACKGROUND

### Technical Field

The present disclosure relates to an information processing apparatus, an information processing method, and a non-transitory storage medium.

### Description of the Related Art

Japanese Patent Laid-Open No. 2002-203015 discloses a taxi calling system. With the taxi calling system according to Japanese Patent Laid-Open No. 2002-203015, a taxi calling terminal transmits information for calling a taxi to a service station. At this time, the service station receives the information for calling a taxi from the taxi calling terminal, and thereby grasps a source position of the taxi calling terminal. Then, the service station transmits position information of the taxi calling terminal and the information for calling a taxi from the taxi calling terminal, to a terminal of a taxi company or a terminal in a taxi.

### SUMMARY

The present disclosure is aimed at increasing convenience of a user who uses a commercial facility.

An information processing apparatus according to a first mode of the present disclosure includes a controller comprising at least one processor configured to:

acquire first information about movement of a shopping cart present inside a commercial facility;

determine, based on the first information, whether there is an indication that a user who is using the shopping cart inside the commercial facility is leaving the commercial facility; and

dispatch a vehicle to a specific location in a case of determining that there is the indication that the user is leaving the commercial facility.

An information processing method according to a second mode of the present disclosure is

an information processing method that is performed by a computer, the method including:

acquiring first information about movement of a shopping cart present inside a commercial facility;

determining, based on the first information, whether there is an indication that a user who is using the shopping cart inside the commercial facility is leaving the commercial facility; and

dispatching a vehicle to a specific location in a case where presence of the indication that the user is leaving the commercial facility is determined.

A non-transitory storage medium according to a third mode of the present disclosure is

a non-transitory storage medium storing a program for causing a computer to perform an information processing method, where the information processing method includes:

acquiring first information about movement of a shopping cart present inside a commercial facility,

determining, based on the first information, whether there is an indication that a user who is using the shopping cart inside the commercial facility is leaving the commercial facility, and

dispatching a vehicle to a specific location in a case where presence of the indication that the user is leaving the commercial facility is determined.

According to the present disclosure, convenience of a user who uses a commercial facility may be increased.

### BRIEF DESCRIPTION OF THE DRAWINGS

FIG. 1 is a diagram illustrating a schematic configuration of a vehicle dispatch system;

FIG. 2 is a diagram illustrating an example of a hardware configuration of a management server;

FIG. 3 is a diagram schematically illustrating an example of functional configurations of a cart, a management server, a vehicle, and a gate according to a first embodiment;

FIG. 4 is a diagram illustrating an inside of a supermarket;

FIG. 5 is a diagram illustrating an example of a table structure of cart information that is stored in a cart information database;

FIG. 6 is a flowchart of a vehicle dispatch process according to the first embodiment;

FIG. 7 is a diagram schematically illustrating an example of functional configurations of a cart, a management server, and a vehicle according to a modification;

FIG. 8 is a diagram schematically illustrating an example of functional configurations of a cart, a management server, a vehicle, and a gate according to a second embodiment;

FIG. 9 is a diagram illustrating an example of a table structure of route information that is stored in a route information database;

FIG. 10 is a diagram illustrating an example of a movement route of the cart;

FIG. 11 is a flowchart of a vehicle dispatch process according to the second embodiment; and

FIG. 12 is a flowchart of a vehicle dispatch process according to a third embodiment.

### DESCRIPTION OF THE EMBODIMENTS

The information processing apparatus according to a first mode of the present disclosure is an information processing apparatus that manages dispatch of vehicles to users who are using a commercial facility. Here, a user uses a shopping cart inside the commercial facility. A controller comprising at least one processor of the information processing apparatus according to the first mode of the present disclosure acquires first information about movement of the shopping cart. The controller of the information processing apparatus may thus grasp how the user, who is using the shopping cart, moves inside the commercial facility. The controller of the information processing apparatus determines, based on the first information, whether there is an indication that the user is leaving the commercial facility. Then, the controller dispatches a vehicle to a specific location in a case of determining that there is the indication that the user is leaving the commercial facility. The specific location here is a location that is determined to be a location where products purchased by the user from the commercial facility are to be loaded into a dispatched vehicle, or where the user is to get in a dispatched vehicle, for example.

As described above, the information processing apparatus dispatches a vehicle to the specific location in the case of determining that there is the indication that the user is leaving the commercial facility. That is, a vehicle may be dispatched by the information processing apparatus, to the specific location and at a timing that is desirable for the user, even if the user does not arrange for dispatch of a vehicle to the specific location at the time of leaving the commercial facility. As a result, convenience of the user who uses the commercial facility may be increased by the information processing apparatus.

In the following, specific embodiments of the present disclosure will be described with reference to the drawings. Dimensions, materials, shapes, relative positions and the like of structural components described in the present embodiments are not intended to limit the technical scope of the present disclosure unless stated otherwise.

### First Embodiment

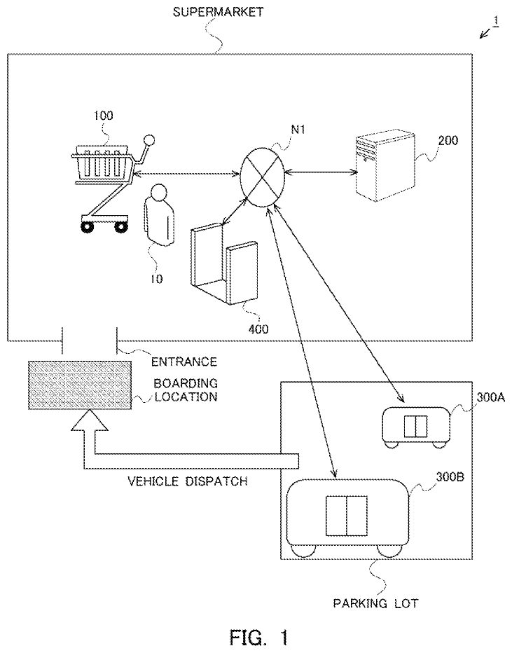

A vehicle dispatch system 1 according to a present embodiment will be described with reference to FIG. 1. FIG. 1 is a diagram illustrating a schematic configuration of the vehicle dispatch system 1. The vehicle dispatch system 1 includes a shopping cart 100 (hereinafter sometimes referred to as “cart 100”), a management server 200, a vehicle 300, and a gate 400. The cart 100, the management server 200, and the gate 400 are present inside a supermarket. Furthermore, the vehicle 300 is parked in a parking lot.

In the vehicle dispatch system 1, the cart 100, the management server 200, the vehicle 300, and the gate 400 exchange various pieces of data over a network N1 configured in an area including the supermarket and the parking lot. The management server 200 connects to the network N1 in a wired or wireless manner. Furthermore, the cart 100, the gate 400, and the vehicle 300 connect to the network N1 in a wireless manner.

(Cart)

The cart 100 is used by a user 10 inside the supermarket. The cart 100 is provided with a position sensor that acquires a current position inside the supermarket. The cart 100 transmits the current position acquired by the position sensor, to the management server 200 over the network N1.

(Gate)

The gate 400 is a gate for reading information for identifying a product in the cart 100 (hereinafter sometimes referred to as “product information”). The product information here is information about an identifier used to identify the product (hereinafter sometimes referred to as “product ID”). The gate 400 is provided with a sensor for reading a radio frequency (RF) tag. When the cart 100 passes through the gate 400, the gate 400 reads, from the RF tag attached to each product sold in the supermarket, the product ID of a product in the cart 100. Furthermore, at this time, an identifier for specifying the cart 100 (hereinafter sometimes referred to as “cart ID”) is also read from an RF tag attached to the cart 100. Then, the gate 400 links the product information for identifying a product in the cart 100 and the cart ID of the cart 100 that are read, and transmits the same to the management server 200.

(Management Server)

The management server 200 is a server that manages dispatch of the vehicle 300 to the user 10 who is using the supermarket. The management server 200 dispatches the vehicle 300 to a boarding location based on movement of the cart 100. Specifically, the management server 200 dispatches the vehicle 300 to the boarding location based on the current position of the cart 100. The boarding location here is provided near an entrance of the supermarket. Furthermore, the boarding location is a location where the user 10 loads products purchased from the supermarket into the vehicle 300. Moreover, the boarding location is a location where the user 10 gets in the vehicle 300. Additionally, the boarding location in the present embodiment corresponds to “specific location” according to the present disclosure.

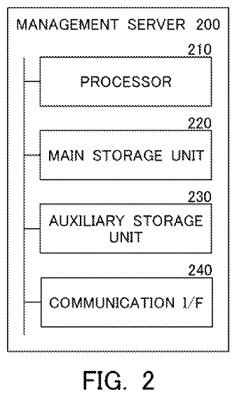

FIG. 2 is a diagram illustrating an example of a hardware configuration of the management server 200. As illustrated in FIG. 2, the management server 200 includes a computer including a processor 210, a main storage unit 220, an auxiliary storage unit 230, and a communication interface (communication I/F) 240. For example, the processor 210 is a central processing unit (CPU) or a digital signal processor (DSP). For example, the main storage unit 220 is a random access memory (RAM). For example, the auxiliary storage unit 230 is a read only memory (ROM). Furthermore, for example, the auxiliary storage unit 230 is a hard disk drive (HDD), or a disk recording medium such as a CD-ROM, a DVD disc, or a Blu-ray disc. Furthermore, the auxiliary storage unit 230 may be a removable medium (a removable storage medium). Here, as the removal medium, an USB memory or an SD card may be cited as an example, for example. The communication I/F 240 is a local area network (LAN) interface board, or a wireless communication circuit for wireless communication, for example.

In the management server 200, the auxiliary storage unit 230 stores an operating system (OS), various programs, various information tables, and the like. Furthermore, in the management server 200, the processor 210 may implement various functions as described later by loading programs stored in the auxiliary storage unit 230 into the main storage unit 220 and by executing the programs. However, one or some or all of functions of the management server 200 may alternatively be implemented by a hardware circuit such as an ASIC or an FPGA. Additionally, the management server 200 does not have to be implemented in a single physical configuration, and may alternatively include a plurality of computers that operate in conjunction with each other. Additionally, the management server 200 according to the present embodiment corresponds to “information processing apparatus” according to the present disclosure. Furthermore, like the management server 200, the cart 100 and the gate 400 also include a computer.

(Vehicle)

The vehicle 300 (a vehicle 300A and a vehicle 300B) is a vehicle that is capable of autonomous traveling. The vehicle 300B is a vehicle that is larger than the vehicle 300A. Accordingly, the vehicle 300B has a larger space for loading goods than the vehicle 300A. Furthermore, the weight of goods that can be loaded is greater for the vehicle 300B than for the vehicle 300A. When instructed by the management server 200 to be dispatched to the boarding location, the vehicle 300 autonomously travels from a parking location to the boarding location. When the user 10 gets in the vehicle 300, the vehicle 300 autonomously travels to a location specified by the user 10.

(Functional Configuration)

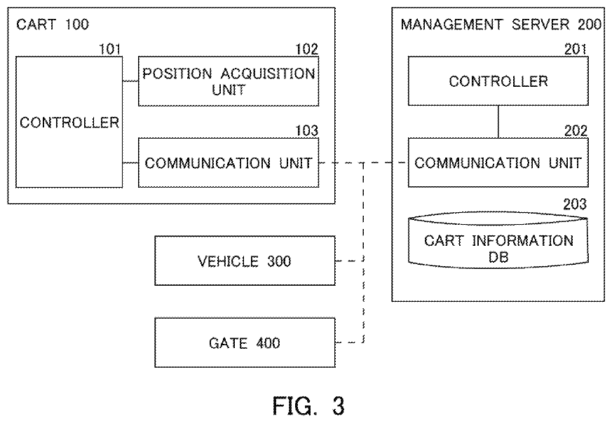

Next, functional configurations of the cart 100, the management server 200, the vehicle 300, and the gate 400 forming the vehicle dispatch system 1 according to the present embodiment will be described with reference to FIG. 3 to FIGS. 5. FIG. 3 is a diagram schematically illustrating an example of the functional configurations of the cart 100, the management server 200, the vehicle 300, and the gate 400 according to the present embodiment.

(Cart 100)

The cart 100 includes a controller 101, a position acquisition unit 102, and a communication unit 103. The controller 101 includes a function of performing arithmetic processing for controlling the cart 100. The controller 101 may be implemented by a processor of the cart 100. The position acquisition unit 102 includes a function of acquiring the current position of the cart 100 inside the supermarket. The position acquisition unit 102 may be implemented by a GPS receiver of the cart 100. The communication unit 103 includes a function of connecting the cart 100 to the network N1. The communication unit 103 may be implemented by a communication I/F of the cart 100.

The controller 101 transmits position information to the management server 200 through the communication unit 103. The position information here is information including the current position of the cart 100 acquired by the position acquisition unit 102. Furthermore, the position information is information also including the cart ID of the cart 100. Additionally, the position information in the present embodiment corresponds to “first information” according to the present disclosure.

(Management Server 200)

The management server 200 includes a controller 201, a communication unit 202, and a cart information database (cart information DB) 203. The controller 201 includes a function of performing arithmetic processing for controlling the management server 200. The controller 201 may be implemented by the processor 210 of the management server 200. The communication unit 202 includes a function of connecting the management server 200 to the network N1. The communication unit 202 may be implemented by the communication I/F 240 of the management server 200.

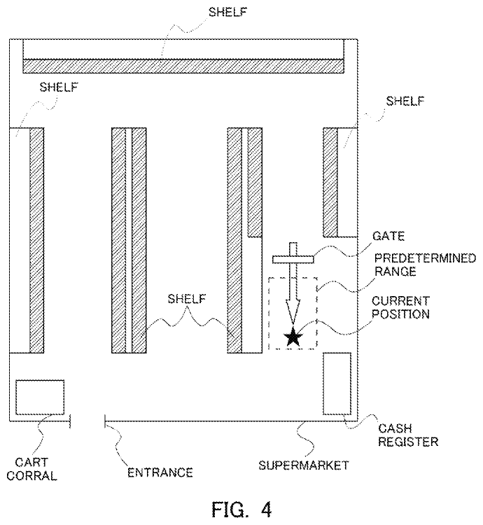

FIG. 4 is a diagram illustrating an inside of a supermarket. As illustrated in FIG. 4, a cart corral where unused carts 100 are kept is provided near an entrance. After entering the supermarket from the entrance, the user 10 takes a cart 100 from the cart corral to use the cart 100. Furthermore, five shelves are provided inside the supermarket. As indicated by shaded parts in FIG. 4, products are placed on the shelves in a manner facing the aisles. Furthermore, a cash register and the gate 400 are provided inside the supermarket, at positions indicated in FIG. 4. The user 10 puts a product to be purchased in the cart 100, passes through the gate 400, and heads to the cash register. Then, the user 10 pays for the product to be purchased, at the cash register. That is, the user 10 who put the product to be purchased in the cart 100 moves in a direction indicated by an open arrow illustrated in FIG. 4.

At this time, the controller 201 receives from the gate 400, by the communication unit 202, the product information for identifying the product in the cart 100 passing through the gate 400. Then, the controller 201 generates cart information based on the product ID, in the product information, of the product in the cart 100. The cart information here is information about a size and a weight of the product in the cart 100. For example, the controller 201 generates the cart information by acquiring information, registered in the auxiliary storage unit 230 in advance, associating the product ID with the size and the weight of the product. Then, the controller 201 stores the generated cart information in the cart information DB 203. The cart information DB 203 here may be implemented by the auxiliary storage unit 230 of the management server 200.

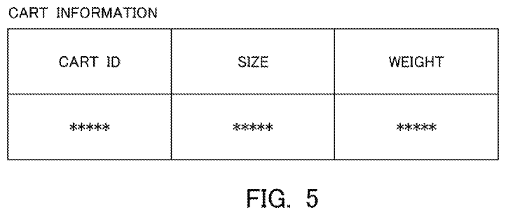

FIG. 5 is a diagram illustrating an example of a table structure of the cart information that is stored in the cart information DB 203. As illustrated in FIG. 5, the cart information includes a cart ID field, a size field, and a weight field. The cart ID that is received from the gate 400 is input in the cart ID field. The size of the product in the cart 100 corresponding to the cart ID is input in the size field. In the case where a plurality of products is in the cart 100, the size of each product is input in the size field. Furthermore, in the case where a plurality of products is in the cart 100, the weight of each product is input in the weight field. Additionally, the cart information in the present embodiment corresponds to “second information” according to the present disclosure.

Furthermore, the controller 201 receives the position information from the cart 100, by the communication unit 202. The controller 201 may thus grasp the current position of the cart 100. In FIG. 4, the current position of the cart 100 is indicated by a star. Furthermore, as illustrated in FIG. 4, a predetermined range is provided near the cash register inside the supermarket. The predetermined range is provided at a location where the user 10 passes through to make payment at the cash register. The predetermined range is provided at such a location that the user 10 is predicted to leave the supermarket when the cart 100 (the user 10) is in the predetermined range. A case where the current position of the cart 100 is within the predetermined range is now assumed. In this case, the user 10 is expected to leave the supermarket. The controller 201 determines whether the current position of the cart 100 is within the predetermined range in the supermarket. Then, when the current position of the cart 100 is within the predetermined range, the controller 201 determines that there is an indication that the user 10 is leaving the supermarket. Additionally, the predetermined range in the present embodiment corresponds to “predetermined location” according to the present disclosure.

Then, when determining that there is the indication that the user 10 is leaving the supermarket, the controller 201 dispatches the vehicle 300 to the boarding location. In other words, the controller 201 dispatches the vehicle 300 to the boarding location when the cart 100 is within the predetermined range.

Furthermore, in the case where the current position of the cart 100 is determined to be within the predetermined range, the controller 201 acquires the cart information about the cart 100 that is within the predetermined range, from the cart information DB 203. Here, the controller 201 acquires the cart information about the cart 100 in relation to which the cart ID included in the position information of the cart 100 matches the cart ID in the cart information stored in the cart information DB 203. Then, the controller 201 selects the vehicle 300 to be dispatched (the vehicle 300A or the vehicle 300B) based on the cart information. Specifically, the controller 201 determines which of the vehicle 300A and the vehicle 300B is to be dispatched, based on the size and the weight of the product that are input in the size field and the weight field of the cart information. For example, in the case where the size of the product in the cart 100 is greater than a capacity of a space in the vehicle 300A for loading goods, the controller 201 selects the vehicle 300B. Furthermore, in the case where the weight of the product is greater than a weight of goods that can be loaded in the vehicle 300A, the controller 201 selects the vehicle 300B.

In the case where a plurality of products is in the cart 100, the controller 201 selects the vehicle 300B when it is not possible to load all the products in the space, in the vehicle 300A, for loading goods. Furthermore, in the case where a plurality of products is in the cart 100, the controller 201 selects the vehicle 300B when a total weight of all the products exceeds the weight of goods that can be loaded in the vehicle 300A.

Then, the controller 201 dispatches the selected vehicle 300 (the vehicle 300A or the vehicle 300B) to the boarding location. Specifically, the controller 201 transmits vehicle dispatch information for dispatching the selected vehicle 300 to the boarding location, to the vehicle 300 in question.

In this manner, the controller 201 selects the vehicle 300 to be dispatched, from the vehicle 300A and the vehicle 300B, based on the cart information. Because the controller 201 dispatches the selected vehicle 300 to the boarding location, the vehicle 300 having a size that is appropriate for the size or the weight of the product purchased by the user 10 may be dispatched.

(Vehicle Dispatch Process)

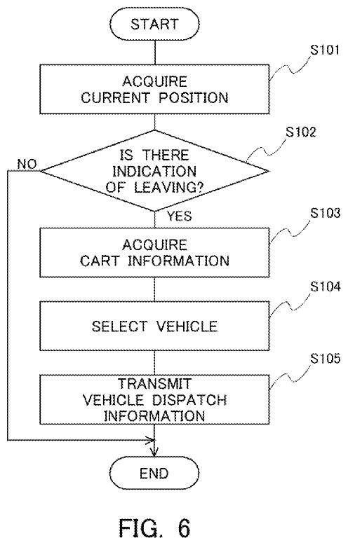

Next, a vehicle dispatch process that is performed by the controller 201 of the management server 200 in the vehicle dispatch system 1 will be described with reference to FIG. 6. FIG. 6 is a flowchart of the vehicle dispatch process according to the present embodiment. The vehicle dispatch process is a process for dispatching the vehicle 300 to the boarding location. The vehicle dispatch process is repeatedly performed.

In the vehicle dispatch process, first, the current position of the cart 100 is acquired in S101. Next, in S102, whether there is an indication that the user 10 is leaving the supermarket is determined. Specifically, whether the current position of the cart 100 is within the predetermined range is determined. In the case where a negative determination is made in S102, it is expected that the user 10 is not leaving the supermarket yet and is going to stay inside the supermarket. Accordingly, the vehicle dispatch process is temporarily ended.

In the case where a positive determination is made in S102, the user 10 is expected to leave the supermarket. Accordingly, in S103, the cart information about the cart 100 within the predetermined range is acquired from the cart information DB 203. Next, in S104, the vehicle 300 to be dispatched is selected from the vehicle 300A and the vehicle 300B based on the acquired cart information. Next, in S105, the vehicle dispatch information is transmitted to the vehicle 300 that is selected in S104. The vehicle dispatch process is then ended. The vehicle 300 receiving the vehicle dispatch information autonomously travels to the boarding location. The user 10 may thereby load the purchased product into the vehicle 300 or get in the vehicle 300 at the boarding location.

As described above, in the case where the management server 200 in the vehicle dispatch system 1 determines that there is an indication that the user 10 is leaving the supermarket, the vehicle 300 is dispatched to the boarding location. Accordingly, even if the user 10 does not arrange for dispatch of a vehicle to the boarding location at the time of leaving the supermarket, the vehicle 300 may be dispatched to the boarding location by the vehicle dispatch system 1 at a timing of the user 10 leaving the supermarket. That is, the vehicle 300 may be dispatched to the boarding location by the vehicle dispatch system at a timing that is desirable for the user 10. As a result, the vehicle dispatch system 1 may increase convenience of the user who uses the supermarket.

(Modification)

Additionally, in the present embodiment, the network N1 is a network that is configured in an area including the supermarket and the parking lot. Additionally, as the network N1, a wide area network (WAN), which is a worldwide public communication network such as the Internet, or a telecommunication network for mobile phones may be adopted, for example.

Furthermore, in the present embodiment, the vehicle 300 is a vehicle that is capable of autonomous traveling. However, the vehicle 300 does not necessarily have to be a vehicle that is capable of autonomous traveling. In this case, the management server 200 transmits the vehicle dispatch information not to the vehicle 300 but to a terminal associated with an attendant who moves the vehicle 300 to the boarding location (hereinafter sometimes referred to as “attendant terminal”), for example. The attendant terminal here is a computer, a mobile terminal or the like carried by the attendant, for example. When the vehicle dispatch information is received, the attendant terminal displays the vehicle dispatch information to the attendant. The attendant may thus grasp that the vehicle 300 is to be dispatched. As a result, the attendant may move the vehicle 300 to the boarding location.

Furthermore, in the present embodiment, the management server 200 selects the vehicle 300 to be dispatched, from a plurality of types (for example, two types) of the vehicle 300 (the vehicle 300A and the vehicle 300B). Alternatively, the vehicle 300 to be dispatched by the management server 200 may be one type of vehicle 300. In the case, the management server 200 dispatches the vehicle 300 without performing selection of the type of vehicle 300 to be dispatched. Furthermore, the vehicle 300 to be dispatched by the management server 200 may be a vehicle that is related to the user 10 (hereinafter sometimes referred to as “user vehicle”). The user vehicle here is a vehicle that is owned by the user 10 and that is parked in the parking lot, for example. Furthermore, the user vehicle may be a shared car or the like that the user 10 is currently using and that is parked in the parking lot, for example. The user 10 inputs information for identifying the user vehicle to the cart 100, for example. Then, the cart 100 transmits the information for identifying the user vehicle to the management server 200. The management server 200 may thereby associate the user vehicle with the cart 100. Then, the management server 200 transmits the vehicle dispatch information to the user vehicle based on the received information for identifying the user vehicle.

Furthermore, in the present embodiment, the predetermined range is provided at a location through which the user 10 passes to make payment at the cash register. However, the predetermined range does not necessarily have to be provided at a location where the user 10 passes through to make payment at the cash register. For example, the predetermined range may be provided at a location where the user 10 passes through after making payment at the cash register.

Furthermore, in the present embodiment, the supermarket has one entrance. However, the supermarket may include a plurality of entrances. In this case, a plurality of predetermined ranges is provided in the supermarket, near the entrances, for example. The management server 200 identifies the predetermined range within which the cart 100 is present, from among the plurality of predetermined ranges. The management server 200 identifies the entrance through which the user 10 leaves the supermarket, based on the identified predetermined range. Then, the management server 200 dispatches the vehicle 300 to the boarding location provided near the identified entrance.

Furthermore, in the present embodiment, when the current position of the cart 100 is within the predetermined range, the management server 200 determines that there is the indication that the user 10 is leaving the supermarket. Additionally, the management server 200 may determine that there is the indication that the user 10 is leaving the supermarket, when the current position of the cart 100 is at a predetermined point. The predetermined point is provided at the cash register, for example. In this case, the management server 200 determines that there is the indication that the user 10 is leaving the supermarket, when the current position of the user 10 is the cash register, or in other words, when the user 10 is making payment at the cash register. Additionally, the predetermined point in the present modification corresponds to “predetermined location” according to the present disclosure.

Furthermore, in the present embodiment, the position acquisition unit 102 of the cart 100 is implemented by a GPS receiver. Additionally, a known method may be adopted as the method used by the position acquisition unit 102 to acquire the current position of the cart 100. For example, the position acquisition unit 102 may acquire the current position of the cart 100 inside the supermarket by positioning based on Wi-Fi, positioning based on a beacon method or the like. Furthermore, the management server 200 may acquire the current position of the cart 100 based on a moving image captured by a camera provided inside the supermarket, without receiving the position information from the cart 100.

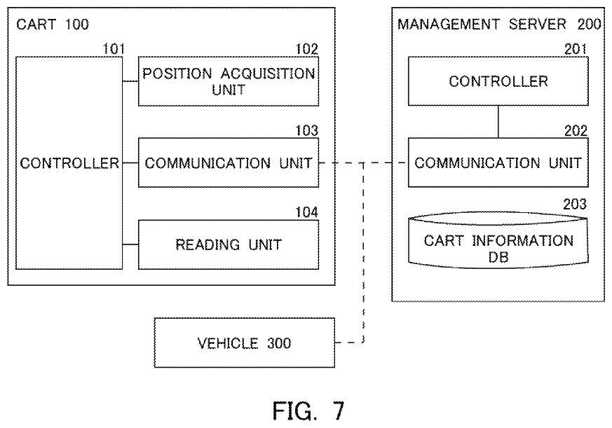

Moreover, the vehicle dispatch system 1 according to the present embodiment includes the gate 400. However, the vehicle dispatch system 1 does not necessarily have to include the gate 400. Functional configurations of the cart 100, the management server 200, and the vehicle 300 according to the present modification will be described with reference to FIG. 7. FIG. 7 is a diagram schematically illustrating an example of the functional configurations of the cart 100, the management server 200, and the vehicle 300 according to the present modification. As illustrated in FIG. 7, the cart 100 includes the controller 101, the position acquisition unit 102, the communication unit 103, and a reading unit 104. The reading unit 104 includes a function of reading the product information for identifying a product in the cart 100. The reading unit 104 here may be implemented by a sensor for reading an RF tag. When the user 10 puts a product in the cart 100, the reading unit 104 reads the product ID of the product in the cart 100 from the RF tag attached to the product. Then, the cart 100 links the cart ID with the product information, that is read, for identifying the product in the cart 100, and transmits the same to the management server 200. Then, the management server 200 generates the cart information based on the product information received from the cart 100.

The gate 400 or the cart 100 does not necessarily have to read the product information by reading the RF tag. For example, the gate 400 or the cart 100 may detect the product information based on an image of the product in the cart 100 that is captured by a camera provided at the gate 400 or the cart 100, and transmit the product information to the management server 200.

Furthermore, in the present embodiment, the management server 200 receives the product information from the gate 400. Then, the management server 200 generates the cart information based on the product information. Alternatively, the management server 200 may receive the cart information from the gate 400 or the cart 100. In this case, the gate 400 or the cart 100 generates the cart information from the product information, and transmits the cart information to the management server 200. Then, the management server 200 stores the received cart information in the cart information DB 203.

Furthermore, in the present embodiment, the cart information is information including the size and the weight of the product in the cart 100. Alternatively, information included in the cart information may be one of the size and the weight of the product in the cart 100.

Furthermore, the management server 200 may receive the cart information from a sensor that is provided at the gate 400 or the cart 100 and that detects the cart information. In this case, for example, in the case where the weight of the product in the cart 100 is to be included in the cart information, the weight of the product may be detected by a weight sensor that is provided at the gate 400 and that is for detecting the weight of one or more products in the cart 100. Alternatively, the weight of the product may be detected by a weight sensor that is provided at the cart 100 and that is for measuring the weight of one or more products in the cart 100. Then, cart information including the detected weight of one or more products may be transmitted from the gate 400 or the cart 100 to the management server 200. Moreover, the sensor for detecting the cart information may be a sensor that detects the size of the product.

Furthermore, detection of the cart information about one or more products in the cart 100 may be performed at the cash register. In this case, the predetermined range is provided at a location where the user 10 passes through after making payment at the cash register. Then, the cash register transmits the cart information about one or more products in the cart 100 detected by the cash register, to the management server 200.

Furthermore, in the present embodiment, the cart information is information including the size and the weight of the product in the cart 100. However, the cart information may also include information about the type of the product, for example. The type of a product indicates whether the product is of a type that needs to be refrigerated or frozen, for example. In the case where a product of a type that needs to be refrigerated or frozen is included in the cart 100, the management server 200 selects and dispatches the vehicle 300 that is provided with a refrigerator or a freezer.

### Second Embodiment

In the first embodiment, whether there is an indication that the user 10 is leaving the supermarket is determined in a case where the current position of the cart 100 is within the predetermined range in the supermarket. By contrast, in a present embodiment, whether there is an indication that the user 10 is leaving the supermarket is determined based on a movement route of the cart 100 in the supermarket. In the following, differences from the first embodiment will be described.

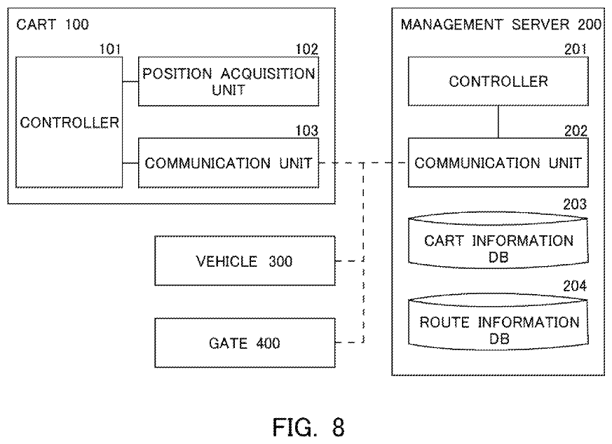

Functional configurations of the cart 100, the management server 200, the vehicle 300, and the gate 400 forming the vehicle dispatch system 1 according to the present embodiment will be described with reference to FIG. 8 to FIG. 10. FIG. 8 is a diagram schematically illustrating an example of the functional configurations of the cart 100, the management server 200, the vehicle 300, and the gate 400 according to the present embodiment.

(Management Server)

As illustrated in FIG. 8, the management server 200 includes the controller 201, the communication unit 202, the cart information DB 203, and a route information database (a route information DB) 204. The route information DB 204 is a database for storing the movement route along which the cart 100 moved in the supermarket. The route information DB 204 may be implemented by the auxiliary storage unit 230 of the management server 200.

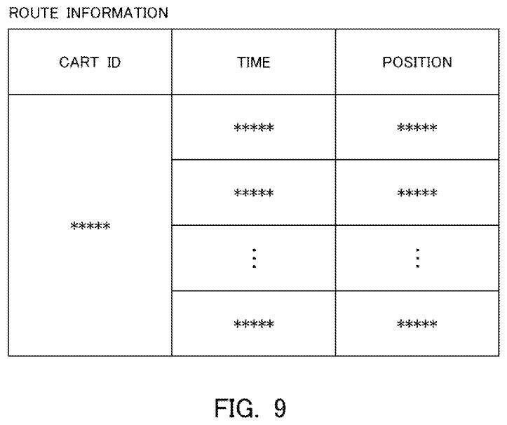

The controller 201 stores the position information received from the cart 100 in the route information DB 204, and generates route information. FIG. 9 is a diagram illustrating an example of a table structure of the route information that is stored in the route information DB 204. As illustrated in FIG. 9, the route information includes a cart ID field, a time field, and a position field. The cart ID that is included in the position information is input in the cart ID field. The time of transmission of the position information by the cart 100 is input in the time field. The current position of the cart 100 at the time that is input in the time field is input in the position field. Additionally, the route information in the present embodiment corresponds to “first information” according to the present disclosure.

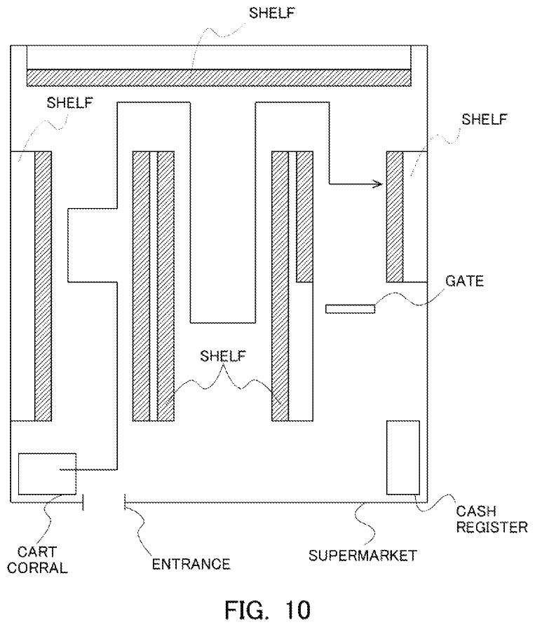

The controller 201 acquires the route information from the route information DB 204. The controller 201 may thereby grasp the movement route of the cart 100. FIG. 10 is a diagram illustrating an example of the movement route of the cart 100. In FIG. 10, the movement route of the cart 100 is indicated by an arrow. As in the first embodiment, the user 10 puts a product to be purchased in the cart 100, passes through the gate 400, and heads to the cash register. At the time of passing in front of a shelf, the user 10 looks at products placed on the shelf. The user 10 may be predicted to leave the supermarket when the user 10 has looked at the products placed on the shelves to a certain extent. Accordingly, the controller 201 specifies, based on the movement route of the cart 100 in the route information, parts of all the shelves in the supermarket in front of which the user 10 passed by (hereinafter sometimes referred to as “passed part(s)”). The controller 201 calculates a proportion of the passed parts to all the shelves. Then, when the proportion of the passed parts is at or greater than a predetermined proportion, the controller 201 determines that there is an indication that the user 10 is leaving the supermarket. When the proportion of the passed parts is smaller than the predetermined proportion, the controller 201 determines that there is no indication that the user 10 is leaving the supermarket. In this manner, the controller 201 determines whether there is an indication that the user 10 is leaving the supermarket, based on the route information.

(Vehicle Dispatch Process)

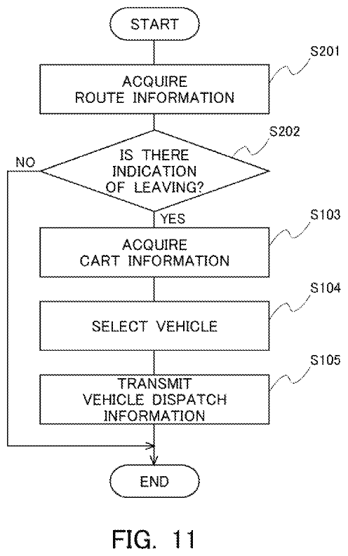

Next, a vehicle dispatch process that is performed by the controller 201 of the management server 200 in the vehicle dispatch system 1 will be described with reference to FIG. 11. FIG. 11 is a flowchart of the vehicle dispatch process according to the present embodiment.

In the vehicle dispatch process, first, the route information about the cart 100 is acquired in S201. Next, in S202, whether there is an indication that the user 10 is leaving the supermarket is determined. That is, whether the proportion of the passed parts is at or greater than the predetermined proportion is determined. In the case where a negative determination is made in S202, it is predicted that the user 10 is not leaving the supermarket yet and is going to stay in the supermarket. Accordingly, the vehicle dispatch process is temporarily ended. In the case where a positive determination is made in S202, the user 10 is predicted to leave the supermarket. Accordingly, as in the first embodiment, the processes from S103 to S105 are performed. Then, the vehicle dispatch process is ended.

Also with the vehicle dispatch system 1 according to the present embodiment, as in the first embodiment, convenience of the user 10 using the supermarket may be increased by the vehicle dispatch system 1.

(Modification)

Additionally, in the present embodiment, the management server 200 determines, based on the route information, whether the proportion of the passed parts is at or greater than the predetermined proportion. The management server 200 thereby determines whether there is an indication that the user 10 is leaving the supermarket. However, the management server 200 does not necessarily have to determine whether the proportion of the passed parts is at or greater than the predetermined proportion to determine whether there is an indication that the user 10 is leaving the supermarket. For example, the management server 200 may determine whether there is an indication that the user 10 is leaving the supermarket, by determining, based on the route information, whether the cart 100 passed through the predetermined range in the supermarket. Specifically, the controller 201 determines that the cart 100 passed through the predetermined range in the supermarket, when, according to the route information, the position of the cart 100 moves out of the predetermined range after being present within the predetermined range. The predetermined range according to the present modification here is provided at such a position that the user 10 is predicted to leave the supermarket when the cart 100 (the user 10) passes through the predetermined range. For example, the predetermined range according to the present modification is provided at a location where the user 10 passes through to make payment at the cash register, or a location where the user 10 passes through after making payment at the cash register. Also in such a case, the management server 200 may determine whether there is an indication that the user 10 is leaving the supermarket, based on the route information.

### Third Embodiment

In a present embodiment, the management server 200 determines whether the vehicle 300 needs to be dispatched to the user 10, based on the cart information. In the following, differences from the first embodiment will be described.

(Vehicle Dispatch Process)

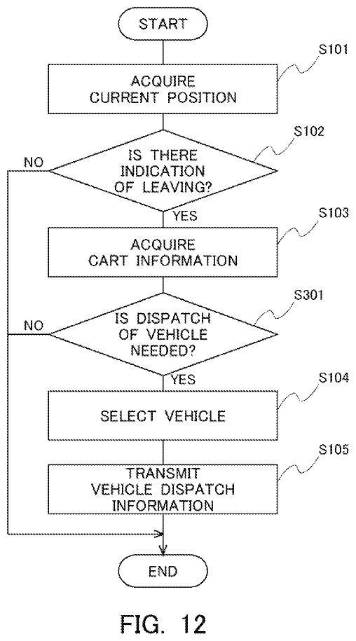

A vehicle dispatch process that is performed by the controller 201 of the management server 200 in the vehicle dispatch system 1 will be described with reference to FIG. 12. FIG. 12 is a flowchart of the vehicle dispatch process according to the present embodiment.

In the vehicle dispatch process, first, as in the first embodiment, the processes from S101 to S103 are performed. Then, in S301, whether the vehicle 300 needs to be dispatched to the user 10 is determined based on the cart information acquired in S103. Specifically, in the case where the size of the product that is input in the size field of the cart information exceeds a predetermined size, the controller 201 determines that the vehicle 300 needs to be dispatched to the user 10. The predetermined size here is set in advance to a size by which it is assumed that the user 10 would have difficulty moving while holding and carrying the purchased product. Moreover, in the case where the weight of the product that is input in the weight field of the cart information exceeds a predetermined weight, the controller 201 determines that the vehicle 300 needs to be dispatched to the user 10. The predetermined weight here is set in advance to a weight by which it is assumed that the user 10 would have difficulty moving while holding and carrying the purchased product. Furthermore, in the case where a plurality of products is in the cart 100, dispatch of the vehicle 300 to the user 10 is determined to be necessary, when the plurality of products has the predetermined size or the predetermined weight by which it is assumed that the user 10 would have difficulty moving while holding and carrying the products.

In the case where a negative determination is made in S301, the vehicle 300 does not have to be dispatched to the user 10, and thus, the vehicle dispatch process is ended. In the case where a positive determination is made in S301, dispatch of the vehicle 300 to the user 10 is estimated to be necessary, and the processes in S104 and S105 are performed as in the first embodiment. Then, the vehicle dispatch process is ended.

In this manner, even if the user 10 who is in a state where dispatch of the vehicle 300 is necessary does not arrange for dispatch of the vehicle 300, the vehicle 300 may be dispatched, by the vehicle dispatch system 1, to the boarding location at the timing of the user 10 leaving the supermarket. As a result, convenience of the user using the supermarket may be increased.

### Other Embodiments

The embodiments described above are merely examples, and the present disclosure may be changed as appropriate within the scope of the disclosure. Furthermore, processes and means described in the present disclosure may be freely combined to the extent that no technical conflict exists.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer via a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), read-only memories (ROMs), random access memories (RAMs), EPROMs, EEPROMs, magnetic cards, flash memories, optical cards, and any type of medium suitable for storing electronic instructions.

What is claimed is:

1. An information processing apparatus comprising a controller comprising at least one processor configured to:
acquire first information about movement of a shopping cart present inside a commercial facility;
determine, based on the first information, whether there is an indication that a user who is using the shopping cart inside the commercial facility is leaving the commercial facility; and
dispatch a vehicle to a specific location in a case of determining that there is the indication that the user is leaving the commercial facility.

2. The information processing apparatus according to claim 1, wherein
the first information includes information about a current position of the shopping cart inside the commercial facility, and
the controller determines that there is the indication that the user is leaving the commercial facility, in a case where the current position is at a predetermined location inside the commercial facility.

3. The information processing apparatus according to claim 1, wherein
the first information includes information about a movement route taken by the shopping cart inside the commercial facility, and
the controller determines whether there is the indication that the user is leaving the commercial facility, based on the movement route.

4. The information processing apparatus according to claim 1, wherein
the vehicle includes a plurality of types of vehicles,
the controller is further configured to
acquire second information about one or more products in the shopping cart, and
select a type of the vehicle to be dispatched from the plurality of types, based on the second information, and
the vehicle of the type that is selected is dispatched to the specific location.

5. The information processing apparatus according to claim 4, wherein the second information is information about at least one of a type, a size, and a weight of the one or more products.

6. The information processing apparatus according to claim 1, wherein
the controller is further configured to
acquire second information about one or more products in the shopping cart, and
determine, based on the second information, whether the vehicle needs to be dispatched to the user, and
the vehicle is not dispatched to the specific location in a case where the user is determined not to need the vehicle to be dispatched.

7. The information processing apparatus according to claim 4, wherein the controller receives the second information from a sensor provided at a specific point inside the commercial facility, the sensor being for detecting the second information.

8. The information processing apparatus according to claim 4, wherein the controller receives the second information from a sensor provided on the shopping cart, the sensor being for detecting the second information.

9. An information processing method that is performed by a computer, the method comprising:
acquiring first information about movement of a shopping cart present inside a commercial facility;
determining, based on the first information, whether there is an indication that a user who is using the shopping cart inside the commercial facility is leaving the commercial facility; and
dispatching a vehicle to a specific location in a case where presence of the indication that the user is leaving the commercial facility is determined.

10. The information processing method according to claim 9, wherein
the first information includes information about a current position of the shopping cart inside the commercial facility, and
presence of the indication that the user is leaving the commercial facility is determined in a case where the current position is at a predetermined location inside the commercial facility.

11. The information processing method according to claim 9, wherein
the first information includes information about a movement route taken by the shopping cart inside the commercial facility, and
whether there is the indication that the user is leaving the commercial facility is determined based on the movement route.

12. The information processing method according to claim 9, wherein
the vehicle includes a plurality of types of vehicles,
the method further comprises
acquiring second information about one or more products in the shopping cart, and
selecting a type of the vehicle to be dispatched from the plurality of types, based on the second information, and
the vehicle of the type that is selected is dispatched to the specific location.

13. The information processing method according to claim 12, wherein the second information is information about at least one of a type, a size, and a weight of the one or more products.

14. The information processing method according to claim 9, further comprising:
acquiring second information about one or more products in the shopping cart; and
determining, based on the second information, whether the vehicle needs to be dispatched to the user, and
the vehicle is not dispatched to the specific location in a case where the user is determined not to need the vehicle to be dispatched.

15. The information processing method according to claim 12, wherein the second information is received from a sensor provided at a specific point inside the commercial facility, the sensor being for detecting the second information.

16. The information processing method according to claim 12, wherein the second information is received from a sensor provided on the shopping cart, the sensor being for detecting the second information.

17. A non-transitory storage medium storing a program for causing a computer to perform an information processing method, wherein the information processing method includes:
acquiring first information about movement of a shopping cart present inside a commercial facility,
determining, based on the first information, whether there is an indication that a user who is using the shopping cart inside the commercial facility is leaving the commercial facility, and
dispatching a vehicle to a specific location in a case where presence of the indication that the user is leaving the commercial facility is determined.

18. The non-transitory storage medium according to claim 17, wherein
the first information includes information about a current position of the shopping cart inside the commercial facility, and
in the information processing method, presence of the indication that the user is leaving the commercial facility is determined in a case where the current position is at a predetermined location inside the commercial facility.

19. The non-transitory storage medium according to claim 17, wherein
the first information includes information about a movement route taken by the shopping cart inside the commercial facility, and
in the information processing method, whether there is the indication that the user is leaving the commercial facility is determined based on the movement route.

20. The non-transitory storage medium according to claim 17, wherein
the vehicle includes a plurality of types of vehicles,
the information processing method further includes
acquiring second information about at one or more products in the shopping cart, and
selecting a type of the vehicle to be dispatched from the plurality of types, based on the second information, and
the vehicle of the type that is selected is dispatched to the specific location.
